(19) United States
(12) Patent Application Publication
(10) Pub. No.: US 2025/0252615 A1
(43) Pub. Date: Aug. 7, 2025

(54) IMAGE PROCESSING METHOD AND APPARATUS, AND ELECTRONIC DEVICE

(71) Applicant: Lenovo (Beijing) Limited, Beijing (CN)

(72) Inventor: Yonghua HU, Beijing (CN)

(21) Appl. No.: 19/035,787

(22) Filed: Jan. 23, 2025

(30) Foreign Application Priority Data
Feb. 1, 2024 (CN) 202410144292.X

(51) Int. Cl. G06T 11/00; G06F 40/30; G06T 5/50; G06V 10/44

(52) U.S. Cl. CPC G06T 11/00; G06F 40/30; G06T 5/50; G06V 10/443

(57) ABSTRACT

An image processing method includes obtaining an image, processing the image based on an image engine to determine feature information included in the image, obtaining input content, determining a target feature from the feature information included in the image based on the input content, and generating a target image based at least on the target feature and the input content. The target image includes a first object corresponding to the target feature and a second object corresponding to a content description of the target image generated based on the input content.

### CROSS-REFERENCE TO RELATED DISCLOSURE

This application claims priority to Chinese Patent Application No. 202410144292.X, filed on Feb. 1, 2024, the entire content of which is incorporated herein by reference.

### TECHNICAL FIELD

The present disclosure generally relates to the field of image processing technologies and, more particularly, to an image processing method and apparatus, and an electronic device.

### BACKGROUND

At present, photo photographing technology can only capture real images of the real world. When users want to get personalized photos, they can only perform post-processing of photos. It is impossible to directly obtain photos of various styles through creative photographing.

### SUMMARY

In accordance with the disclosure, there is provided an image processing method including obtaining an image, processing the image based on an image engine to determine feature information included in the image, obtaining input content, determining a target feature from the feature information included in the image based on the input content, and generating a target image based at least on the target feature and the input content. The target image includes a first object corresponding to the target feature and a second object corresponding to a content description of the target image generated based on the input content.

Also in accordance with the disclosure, there is provided an electronic device including an image acquisition apparatus configured to obtain an image and a processor configured to process the image based on an image engine to determine feature information included in the image, obtain input content, determine a target feature from the feature information included in the image based on the input content, and generate a target image based at least on the target feature and the input content. The target image includes a first object corresponding to the target feature and a second object corresponding to a content description of the target image generated based on the input content.

Also in accordance with the disclosure, there is provided an image processing method including inputting a candidate image into an image-to-text model to generate text information, determining, based on a semantic model, a similarity between the text information of the candidate image and text information of an input content, and in response to the similarity meeting a target threshold, outputting the candidate image as a target image.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained based on these drawings without any creative work.

In the drawings, the same or corresponding reference numerals indicate the same or corresponding parts.

FIG. 1 is a flowchart of an image processing method consistent with embodiments of the present disclosure.

FIG. 2 is a schematic diagram showing generation of a target image consistent with embodiments of the present disclosure.

FIG. 3 is a schematic structural diagram of an image processing apparatus consistent with embodiments of the present disclosure.

FIG. 4 is a schematic structural diagram of an electronic device consistent with embodiments of the present disclosure.

### DETAILED DESCRIPTION OF THE EMBODIMENTS

Embodiments of the present disclosure will be described in connection with the drawings. Obviously, the described embodiments are only some of the embodiments of the present disclosure, but not all of the embodiments. Based on the embodiments in the present disclosure, all other embodiments obtained by those skilled in the art without making creative work are within the scope of the present disclosure.

The present photo photographing technology cannot directly obtain photos of various styles through creative photographing. Therefore, to achieve creative photo photographing to obtain photos of various styles, the present disclosure provides an image processing method and apparatus, and an electronic device. The electronic device provided by the present disclosure may be a mobile phone, a computer, a tablet computer, or other devices.

This specification describes various generative models is proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). These LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate a response that is responsive to the NL based input and that is to be rendered at the client device. In many instances, these LLMs can cause textual content to be included in the response. In some instances, these LLMs can additionally, or alternatively, cause multimedia content, such as images, to be included in the response (e.g., based on causing image retrieval to be performed, based on causing image generation models to generate images, etc.).

This specification describes a system implemented as computer programs on one or more computers in one or more locations that implements a text-to-image generative model configured to generate an image conditioned a text prompt. In some cases, the text prompt specifies a particular style of the image, the text-to-image generative model processes the text prompt to generate an image having the particular sty le specified by the text prompt. In some cases, the text prompt specifies a particular object (e.g., a particular person, a particular animal, a particular car, a particular boat, etc.) or specific instance of an object that should appear in the image, the text-to-image generative model processes the text prompt to generate an image depicting the particular object/instance specified by the text prompt. In some other cases, the text prompt specifies both the particular sty le of the image and the particular object/instance that should appear in the image, the text-to-image generative model processes the text prompt to generate an image having (i) the particular style and (ii) depicting the particular object/instance.

The technical scheme of the embodiment of the present disclosure will be described below in conjunction with the drawings in the embodiments of the present disclosure.

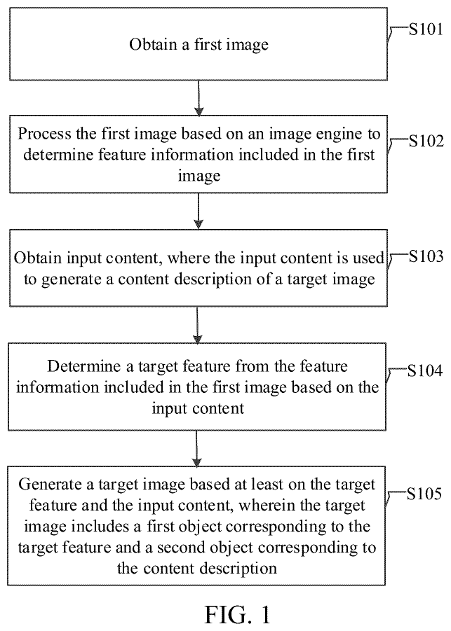

FIG. 1 shows a flowchart of an image processing method provided by the present disclosure. As shown in FIG. 1, in one embodiment, the image processing method includes S101 to S105.

At S101, a first image is obtained.

In one embodiment, an image acquisition apparatus may be used to instantly capture an image needed by the user as the first image. Alternatively, in some other embodiments, the needed image may also be obtained from the user's album as the first image. The user's album may be a local album or a cloud album. Alternatively, in yet some other embodiments, the needed image may also be downloaded from the network as the first image. The image acquisition apparatus may be a camera, or a mobile phone that is able to capture images.

S102, the first image is processed based on an image engine to determine feature information included in the first image.

The image engine may include an image feature extraction component. In one embodiment, the image feature extraction component in the image engine may be used to extract the feature information such as texture, color or shape of each element in the first image. The element(s) in the first image may include foreground objects and background areas in the first image. Foreground objects may be people, animals, objects, etc. The feature extraction component may use a software program including a SIFT (Scale Invariant Feature Transform) algorithm, a software program including a HOG (Histogram of Oriented Gradients) algorithm, or a deep learning model such as a convolutional neural network.

S103, input content is obtained, where the input content is used to generate a content description of a target image.

In one embodiment, the input content may be used to generate the content description of the target image, and the input content may include all element(s) needed for the target image. For example, when the input content is “generate a selfie of user A on a beach in Maldives,” the element(s) needed to generate the target image may include “an image of user A” and “any beach landscape image in Maldives.”

The input content may be voice content or text content. When the input content is voice content, the voice content may be converted into corresponding text content. Based on the natural language processing model, the text content may be understood and processed, and the semantic feature(s) of the vocabulary contained in the text content that are able to be used to generate the target image may be extracted. A feature set including the semantic feature(s) of the vocabulary that are able to be used to generate the target image may be obtained as the content description of the generated target image. The natural language processing model may include RNN (Recurrent Neural Networks) or CNN (Convolutional Neural Networks) that is able to capture context information.

S104, target feature(s) are determined from the feature information included in the first image based on the input content.

In one embodiment, when the input content includes all the element(s) needed to generate the target image, all element(s) included in the first image may be determined through the feature information included in the first image. Then, the element(s) included in the first image may be compared with the element(s) included in the input content, the element(s) included in the first image that overlap with the element(s) included in the input content may be retained, and the feature(s) corresponding to the overlapping element(s) may be determined as the target feature(s).

By determining the target feature(s) from the feature information included in the first image through the input content, it may be possible to generate the target image using the existing element(s) in the first image, thereby improving the generation efficiency of the target image.

S105, the target image is generated based on the target feature(s) and the input content, where the target image includes the first object corresponding to the target feature(s) and the second objects corresponding to the content description.

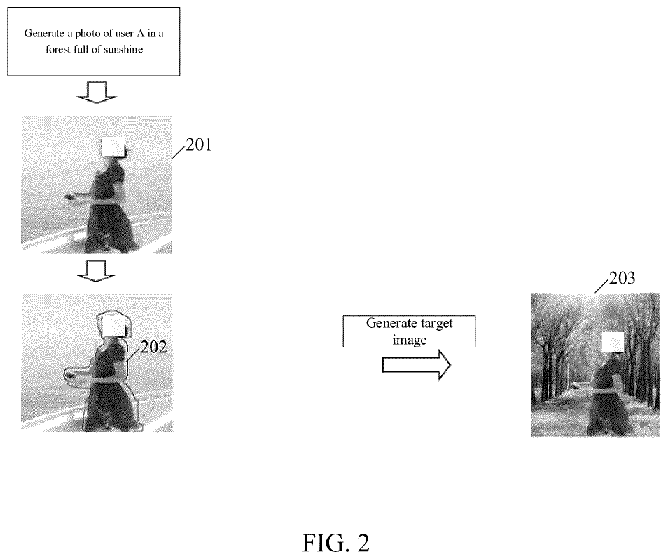

As shown in FIG. 2, which is a schematic diagram showing generation of the target image, in one embodiment, the input content is “generate a photo of user A in a forest full of sunshine,” and the input content includes the element(s) “user A,” “forest full of sunshine” and “photo” needed to generate the target image. The first image 201 is obtained, and the character included in the image 201 is the character image of user A. The feature information included in the first image 201, that is, the feature information of the half-body image 202 of user A and the feature information of the background area image, is extracted by the image engine. Then, the element(s) included in the input content are compared with the element(s) corresponding to the feature information included in the first image 201, and the feature(s) of the overlapping element “half-body image of user A” are obtained as the target feature(s). Then, based on the target feature(s) and the other element(s) “forest full of sunshine” and “photo” remaining in the input content, the target image 203 is generated. The target image 203 includes the foreground area of the half-body image of user A and the background area of the forest full of sunshine.

In the image processing method provided by the present disclosure, the first image may be obtained. Then, the first image may be processed based on the image engine to determine the feature information included in the first image. The input content may be obtained, and the input content may be used to generate the content description of the target image. The target feature(s) may be determined from the feature information included in the first image based on the input content. The target image may be generated based on the target feature(s) and the input content, and the target image may include the first object corresponding to the target feature(s) and the second object corresponding to the content description. The content description of the target image may be generated based on the input content and the target feature(s) needed to generate the target image may be determined from the first image using the input content, that is, the target feature(s) in the first image may be flexibly determined using the input content. And then the first object of the target image may be generated based on the target feature(s) and the second objects of the target image may be generated using the content description, thereby achieving the generation of creative photos with diverse styles and improving the user experience.

In one embodiment, determining the target feature(s) from the feature information included in the first image based on the input content may include:
A1, based on a first feature set and a second feature set, determining matching feature(s) in the first feature set and the second feature set, where the matching feature(s) are used as target feature(s).

The first feature set and the second feature set may be feature sets of a same type. The first feature set may be a feature set corresponding to the first image, and the second feature set may be a feature set corresponding to the input content.

In one embodiment, a set including the feature of each element in the extracted first image may be used as the first feature set, and a set including the feature of each element included in the input content may be used as the second feature set. The first feature set and the second feature set may belong to the same type of feature set. For example, when the feature(s) included in the first feature set are a feature matrix corresponding to the element(s) included in the first image, the feature(s) included in the second feature set may also be a feature matrix corresponding to the element(s) included in the input content. When the feature(s) included in the first feature set are the element(s) included in the first image, the feature(s) included in the second feature set may also be the element(s) included in the input content.

For each feature in the first feature set, the similarity between the feature and each feature in the second feature set may be calculated. When there is a feature in the second feature set whose similarity with the feature is higher than a preset similarity threshold, the feature in the second feature set whose similarity with the feature is higher than the preset similarity threshold may be determined as a matching feature. The matching feature(s) in the first feature set determined may be used as the target feature(s).

The similarity between the feature in the first feature set and the feature in the second feature set may be calculated using the cosine similarity algorithm or the mean square error algorithm.

For example, when the first image is a landscape picture including user A and the background scenery in the landscape picture is a highway, the feature(s) included in the first feature set may be an image matrix X1 representing user A and an image matrix X2 representing the highway. The input content may be “generate a photo of user A in a forest full of sunshine.” The feature(s) included in the second feature set may include an image matrix Y1 corresponding to user A and an image matrix Y2 of the forest full of sunshine.

For the image matrix X1 representing user A, the similarity between the image matrix X1 representing user A and the image matrix Y1 corresponding to user A and the image matrix Y2 of the forest full of sunshine may be calculated. When the similarity between the image matrix X1 representing user A and the image matrix Y1 corresponding to user A is greater than the preset similarity threshold, the image matrix X1 representing user A may be determined as a matching matrix. For the image matrix X2 representing the highway, the similarity between the image matrix X2 representing the highway and the image matrix Y1 corresponding to user A and the image matrix Y2 of the forest full of sunshine may be calculated. When the similarity between the image matrix X2 representing the highway and the image matrix Y1 corresponding to user A and the image matrix Y2 of the forest full of sunshine is not greater than the preset similarity threshold, the image matrix X2 representing the highway may not be a matching matrix. Therefore, it may be determined that the target feature(s) include the image matrix X1 representing user A.

The preset similarity threshold may be set according to the actual application scenario, for example, it may be set to 98% or 99%.

In one embodiment, the generation of the target image based on the target feature(s) and the input content may include B1-B3.

At B1, the first object corresponding to the target feature(s) in the first image is determined.

In one embodiment, the target feature(s) may include the positions of the first object in the first image. The area corresponding to the target feature(s) in the first image may be extracted through the position and area information included in the target feature(s), and the objects in the area may be determined as the first object. For example, the target feature(s) may include the position information of each pixel in the half-body image of user A, and the area corresponding to the half-body image of user A in the first image may be extracted according to the position information of each pixel as the first object.

At B2, a second image is generated based on the non-matching feature(s) in the second feature set.

The feature(s) in the second feature set that are able to match the first feature set may be the matching feature(s), and the other feature(s) in the second feature set that are not matching feature(s) may be the non-matching feature(s). In the present disclosure, a new image may be generated as a second image based on the non-matching feature(s). For example, the second feature set may include a feature TI of the half-body image of user A, a feature T2 of the Maldives beach image, and a feature T3 of the blue sky and white clouds image. The feature T1 of the half-body image of user A may be a matching feature, the feature T2 of the Maldives beach image and the feature T3 of the blue sky and white clouds may be non-matching feature(s). An image including the Maldives beach and the blue sky and white clouds may be generated as the second image based on the feature T2 of the Maldives beach image and the feature T3 of the blue sky and white clouds image.

At B3, the target image is obtained by fusing based on the first object and the second image.

The first object may be fused into the second image, and the generated fused image may be used as the target image. For example, the generated image including the Maldives beach and the blue sky and white clouds may be the second image, and the first object may include the area corresponding to the half-body image of user A in the first image. Therefore, the area corresponding to the half-body image of user A in the first image may be extracted and fused into the second image, the half-body image of user A may be used as the foreground area of the fused image, and the image area of the Maldives beach and the blue sky and white clouds may be used as the background area of the fused image. The obtained fused image may be the target image. The target image may include all element(s) in the input content.

By adopting this method, the new target image may be generated according to user needs by utilizing existing element(s) in the first image and the second image generated according to the non-matching feature(s) in the second feature set. This may not only meet the user's diverse photography needs but also simplify or eliminate the user's subsequent photo editing operations, thereby improving photography efficiency.

In another embodiment, the generation of the target image based on the target feature and the input content may include C1-C3.

At C1, the first object corresponding to the target feature(s) in the first image is determined.

For the details of C1, references may be made to above description of B1, which will not be repeated here.

At C2, the second image is determined by screening based on the non-matching feature(s) in the second feature set and the feature information of each image in a picture set.

In one embodiment, the picture set may be a local album or a cloud album of an electronic device, such as a mobile phone album or a user cloud album. In this step, the similarity between the image feature(s) of each image in the picture set and the non-matching feature(s) in the second feature set may be calculated based on the non-matching feature(s) in the second feature set. When there is an image with a similarity greater than a similarity threshold, the image may be determined as the second image. The similarity threshold may be set according to the actual application scenario, for example, it may be set to 97% or 98%.

At C3, the target image is obtained by fusing based on the first object and the second image.

The first object may be fused into the second image, and the generated fused image may be used as the target image.

By adopting this method, the new target image may be generated according to user needs by using the existing element(s) in the first image and the second image including the non-matching feature(s) in the second feature set, which not only meets the user's diverse photography needs but also simplify or eliminate the user's subsequent photo editing operations, thereby improving photography efficiency.

In another embodiment, the generation of the target image based on the target feature and the input content may include D1-D5:

At D1, the first object corresponding to the target feature in the first image is determined.

For the details of D1, references may be made to above description of B1, which will not be repeated here.

At D2, a first feature and a second feature are determined based on the non-matching feature(s) of the second feature set, where the first feature is used to indicate the target object.

In one embodiment, the target object may be a person, an animal, or a landscape element.

At D3, the target object is determined by screening based on the first feature and the feature information of each image in the picture set.

The target object may also appear on the images in the picture set. Therefore, the first feature may be used to compare the feature information of each picture in the picture collection, calculate the feature similarity between the first feature and the feature information of each picture in the picture collection, perform filtering to obtain the feature information whose feature similarity is greater than the feature similarity threshold, and determine the object of the picture in the picture collection corresponding to the feature information as the target object. The feature similarity threshold may be set according to the actual application scenario, for example, it may be set to 97% or 98%.

For example, the non-matching feature(s) of the second feature set may include the feature T2 of the Maldives beach image, the feature T3 of the blue sky and white cloud image, and the feature T4 of the half-body image of user B. Therefore, the feature T4 of the half-body image of user B may be used as the first feature, and the feature T2 of the Maldives beach image and the feature T3 of the blue sky and white cloud image may be used as the second feature. The target object indicated by the first feature may be the half-body image of user B. Then, the images in the local album may be obtained, and the feature similarity between the image feature(s) in each image in the local album and the feature T4 of the half-body image of user B may be calculated. The image with a feature similarity greater than the preset feature similarity threshold may be determined as the selected image, and the object corresponding to the feature T4 of the half-body image of user B in the selected image may be determined as the target object.

At D4, the second image is generated based on the second feature.

In one embodiment, a new image may be generated as the second image according to each second feature. For example, the second feature may include the feature T2 of the Maldives beach image and the feature T3 of the blue sky and white clouds image. Therefore, an image including the Maldives beach and the blue sky and white clouds may be generated as the second image according to the feature T2 of the Maldives beach image and the feature T3 of the blue sky and white clouds image.

At D5, the target image is obtained by fusing based on the first object, the second object, and the second image.

The first object and the second object may be fused into the second image, and the generated fused image may be used as the target image. For example, the generated image including the Maldives beach and blue sky and white clouds may be the second image, the first object may be the area corresponding to the half-body image of user A in the first image, and the second image may be the area corresponding to the half-body image of user B in the image in the local album. Then, the area corresponding to the half-body image of user A in the first image and the area corresponding to the half-body image of user B in the image in the local album may be extracted, and the extracted area corresponding to the half-body image of user A and the area corresponding to the half-body image of user B may be fused into the second image. The half-body image of user A and the half-body image of user B may be used as the foreground area of the fused image, and the image area of the Maldives beach and blue sky and white clouds may be used as the background area of the fused image, and the obtained fused image may be the target image.

Using this method, the new target image may be generated according to user needs by using the existing element(s) in the first image and the second image generated by the non-matching feature(s) in the second feature set, which not only meets the user's diverse photography needs but also simplifies or eliminates the user's subsequent photo editing operations, thereby improving photography efficiency. Moreover, objects not in the first image may be supplemented through the local album, and for objects not in the local album, a corresponding image may be directly generated based on the second feature in the non-matching feature(s) in the input content, which greatly improves the user experience.

In one embodiment, obtaining the first image may include:
E1, obtaining the first image through an image acquisition apparatus, where the first image includes the geographical location at which the first image is obtained.

Based on the first feature set and the second feature set, determining the matching feature(s) matched in the first feature set and the second feature set may include: determining feature(s) in the first feature set corresponding to the geographical location as the matching feature(s).

In one embodiment, the image acquisition apparatus may simultaneously obtain the current geographical location information and time information when acquiring the image, and store the geographical location information and time information as the image information of the acquired image in the file corresponding to the image. For example, after the image is acquired by the image acquisition apparatus, an image file may be generated, and the image file may include description information of the element(s) included in the image, and the location information and the time information of the acquisition of the image. In one embodiment, a corresponding smart album may be generated according to the image description information included in the image file. For example, an album of images all taken at a certain place may be generated, and images taken at the same photographing place may be stored in the album. Or an album of images all including the same object may be generated, and images including the object may be stored in the album.

The first image obtained may include the location information and time information corresponding to the acquisition of the image. When matching the feature(s) included in the first feature set and the second feature set, the location information of the image may be also one of the matching conditions.

In one embodiment, generating the target image based on the target feature and the input content may include:
F1, generating a candidate image based on the target feature and the input content, and processing the candidate image based on an image-to-text model to generate text information; and
F2, determining the similarity between the text information of the candidate image and the text information of the input content based on the semantic model, and, when the similarity meets the target threshold, taking the candidate image as the needed target image.

In one embodiment, the image-to-text model may be a model that is able to generate descriptive text or speech for an image, and is an example of generative models. A generative model is a machine learning model designed to create new data that resembles the training data. Generative artificial intelligence (AI) models learn the patterns and distributions of the training data, then apply those understandings to generate novel content in response to new input data. Generative models have a wide range of applications, including image generation, speech synthesis, and natural language generation. With the image-to-text model, an input image may be processed using, for example, convolutional neural networks (CNNs) to extract spatial features (e.g., shapes, textures, and objects) from the image, and the extracted features may be processed using an RNN, a long-term memory (LTM) network, or a transformer to generate a sequence of words, which may be output as descriptive text or speech.

Other types of generative models can include text-to-image model and image-to-image model. The text-to-image model may generate images based on textual descriptions. With the text-to-image model, input text (e.g., a sentence or a phrase) is processed using a language model (such as bidirectional encoder representation from transformers (BERT), generative pre-trained transformer (GPT), or contrastive language-image pre-training (CLIP)) to transform the input text into a vector representation, which may then be fed into, e.g., a generative adversarial network (GAN) or a diffusion model to map textual features to visual features. The image-to-image model may generate new images by transforming an input image based on specific conditions or tasks. With the image-to-image model, an input image may be processed through several layers of network to extract important features, such as textures, shapes, and spatial relationships within the image, which may then be used to generate a corresponding output image that reflects a specific transformation.

For the generated target image, the descriptive text corresponding to the target image, i.e., text information, may be generated according to the image-to-text model. Then, the text similarity between the generated text information and the text information corresponding to the input content may be calculated. When the similarity is not less than the target threshold, the generated target image may be determined as the needed target image. The similarity less than the target threshold may indicate that there may be a large difference between the generated target image and the image described by the input content, and the target image may need to be regenerated. The target threshold may be set to 99% or 99.5% according to the actual scenario.

By adopting this method, the generated target image may be verified to ensure that the generated target image is an image corresponding to the input content, thereby improving the accuracy of the generated target image.

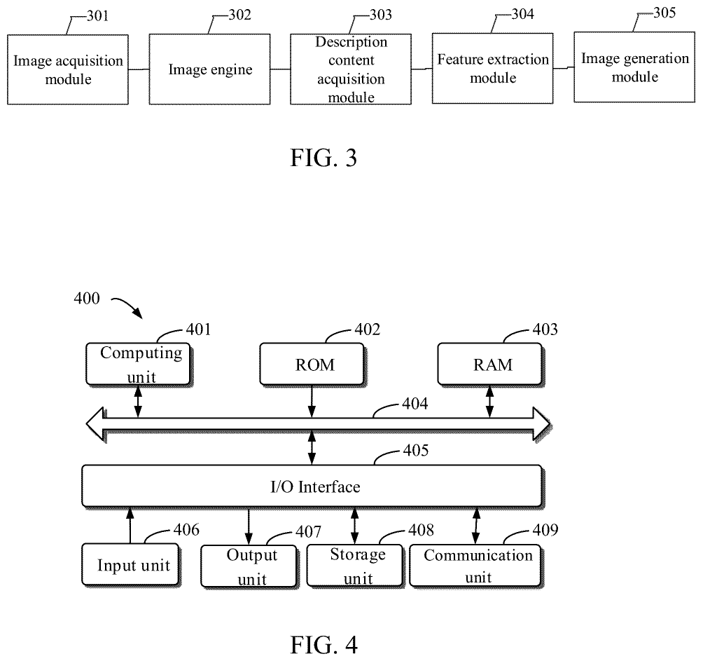

The present disclosure also provides an image processing apparatus. In one embodiment, as shown in FIG. 3, which is a schematic structural diagram of an image processing apparatus, the apparatus includes:
an image acquisition module 301, configured to obtain a first image;
an image engine 302, configured to process the first image and determine feature information included in the first image;
a description content acquisition module 303, configured to obtain input content, where the input content is used to generate a content description of a target image;
a feature extraction module 304, configured to determine a target feature from the feature information included in the first image based on the input content; and
an image generation module 305, configured to generate the target image based on the target feature and the input content, where the target image includes a first object corresponding to the target feature and a second object corresponding to the content description.

Using the image processing apparatus provided by the present disclosure, the first image may be obtained. The first image may be processed based on the image engine to determine the feature information included in the first image. The input content may be obtained, and may be used to generate the content description of the target image. The target feature may be determined from the feature information included in the first image based on the input content. The target image may be generated based on the target feature and the input content. The target image may include a first object corresponding to the target feature and a second object corresponding to the content description. The content description of the target image may be generated by inputting the content and the target feature needed to generate the target image may be determined from the first image using the input content, that is, the target feature in the first image may be flexibly determined using the input content. And then the first object of the target image may be generated based on the target feature and the second object of the target image may be generated using the content description, thereby achieving the generation of creative photos with diverse styles and improving the user experience.

In one embodiment, the feature extraction module 304 may be configured to determine the matching feature(s) in the first feature set and the second feature set based on the first feature set and the second feature set. The matching feature(s) may be used as the target feature. The first feature set and the second feature set may belong to the same type of feature sets. The first feature set may be the feature set corresponding to the first image, and the second feature set may be the feature set corresponding to the input content.

In one embodiment, the image generation module 305 may be configured to: determine the first object corresponding to the target feature in the first image; generate the second image based on the non-matching feature(s) in the second feature set; and fuse the target image based on the first object and the second image.

In one embodiment, the image generation module 305 may be configured to: determine the first object corresponding to the target feature in the first image; determine the second image based on the non-matching feature(s) in the second feature set and the feature information of each picture in the picture set; and fuse the target image based on the first object and the second image.

In one embodiment, the image generation module 305 may be configured to: determine the first object corresponding to the target feature in the first image; determine the first feature and the second feature based on the non-matching feature(s) in the second feature set, where the first feature is used to indicate the target object; determine the target object based on the first feature and the feature information of each picture in the picture set; and generate the second image based on the second feature; and fuse the target image based on the first object, the second object, and the second image.

In one embodiment, the image acquisition module 301 may be configured to obtain the first image through an image acquisition apparatus. The first image may include the geographic location of the first image. Based on the first feature set and the second feature set, determining the matching feature(s) that match in the first feature set and the second feature set may include: the first feature set includes the geographic location to determine whether it belongs to the matching feature(s).

In one embodiment, the apparatus may further include a verification module (not shown in the drawings). The verification model may be configured to: process the a candidate image, generated based on the target feature and the input content, based on the image-to-text model to generate text information; based on the semantic model, determine the similarity between the text information of the target image and the text information of the input content; and, when the similarity meets the target threshold, use the target image as the needed target image.

The present disclosure also provides an electronic device. The electronic device may include an image acquisition apparatus configured to acquire images and a processor.

The processor may be configured to: obtain the first image through the image acquisition apparatus; process the first image based on the image engine to determine the feature information included in the first image; obtain the input content, where the input content is used to generate a content description of a target image; determine the target feature from the feature information included in the first image based on the input content; and generate the target image based on the target feature and the input content, where the target image includes a first object corresponding to the target feature and a second object corresponding to the content description.

As shown in FIG. 4, which is a schematic structural diagram of an exemplary electronic device 400, the electronic device is intended to represent various forms of digital computers, such as laptop computers, desktop computers, workstations, personal digital assistants, servers, blade servers, mainframe computers, or other suitable computers. The electronic device may also represent various forms of mobile devices, such as personal digital processing, cellular phones, smart phones, wearable devices, or other similar computing devices. The components shown herein, their connections and relationships, and their functions are merely examples and are not intended to limit the implementation of the present disclosure described and/or needed herein.

As shown in FIG. 4, the device 400 includes: a computing unit 401, configured to perform various appropriate actions and processes according to a computer program stored in a read-only memory (ROM) 402 or a computer program loaded from a storage unit 408 into a random access memory (RAM) 403. In RAM 403, various programs and data needed for the operation of the device 400 may also be stored. The computing unit 401, ROM 402, and RAM 403 may be connected to each other via a bus 404. An input/output (I/O) interface 405 may also be connected to the bus 404.

Multiple components in the device 400 may connected to the I/O interface 405, including: an input unit 406, such as a keyboard, a mouse, etc.; an output unit 407, such as various types of displays, speakers, etc.; a storage unit 408, such as a disk, an optical disk, etc.; and a communication unit 409, such as a network card, a modem, a wireless communication transceiver, etc. The communication unit 409 may allow the device 400 to exchange information/data with other devices through a computer network such as the Internet and/or various telecommunication networks.

The computing unit 401 may be various general and/or special processing components with processing and computing capabilities. Some examples of the computing unit 401 include, but are not limited to, a central processing unit (CPU), a graphics processing unit (GPU), various special artificial intelligence (AI) computing chips, various computing units running machine learning model algorithms, a digital signal processor (DSP), or any appropriate processor, controller, microcontroller, etc. The computing unit 401 may perform the various methods and processes described above, such as the image processing method. For example, in some embodiments, the image processing method may be implemented as a computer software program, which is tangibly contained in a machine-readable medium, such as a storage unit 408. In some embodiments, part or all of the computer program may be loaded and/or installed on the device 400 via the ROM 402 and/or the communication unit 409. When the computer program is loaded into the RAM 403 and executed by the computing unit 401, one or more steps of the image processing method described above may be performed. Alternatively, in other embodiments, the computing unit 401 may be configured to perform the image processing method in any other suitable manner (e.g., by means of firmware).

The electronic device 400 may also include an image acquisition apparatus.

Various embodiments of the systems and techniques described above herein may be implemented in digital electronic circuit systems, integrated circuit systems, field programmable gate arrays (FPGAs), application specific integrated circuits (ASICs), application specific standard products (ASSPs), integrated systems on chips (SOCs), complex programmable logic devices (CPLDs), computer hardware, firmware, software, and/or combinations thereof. These various embodiments may include: being implemented in one or more computer programs that can be executed and/or interpreted on a programmable system including at least one programmable processor, which may be a dedicated or general-purpose programmable processor that can receive data and instructions from a storage system, at least one input device, and at least one output device, and transmit data and instructions to the storage system, the at least one input device, and the at least one output device.

The program code for implementing the methods disclosed herein may be written in any combination of one or more programming languages. These program codes may be provided to a processor or controller of a general-purpose computer, a dedicated computer, or other programmable data processing device, such that the program code, when executed by the processor or controller, causes the functions/operations specified in the flowchart and/or block diagram to be implemented. The program codes may be executed entirely on the machine, partially on the machine, partially on the machine and partially on a remote machine as a stand-alone software package, or entirely on a remote machine or server.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media would include electrical connections based on one or more wires, a portable computer disk, a hard disk, a random access memory (RAM), a read-only memory (ROM), an erasable programmable read-only memory (EPROM or flash memory), optical fiber, a portable compact disk read-only memory (CD-ROM), an optical storage device, a magnetic storage device, or any suitable combination thereof.

To provide interaction with a user, the systems and techniques described herein may be implemented on a computer having: a display device (e.g., a CRT (cathode ray tube) or LCD (liquid crystal display) monitor) for displaying information to the user; and a keyboard and pointing device (e.g., a mouse or trackball) through which the user can provide input to the computer. Other types of devices may also be used to provide interaction with the user; for example, the feedback provided to the user may be any form of sensory feedback (e.g., visual feedback, auditory feedback, or tactile feedback); and the input from the user may be received in any form (including acoustic input, voice input, or tactile input).

The systems and techniques described herein may be implemented in a computing system that includes a backend component (e.g., as a data server), or a computing system that includes a middleware component (e.g., an application server), or a computing system that includes a frontend component (e.g., a user computer with a graphical user interface or a web browser through which the user can interact with an implementation of the systems and techniques described herein), or a computing system that includes any combination of such backend components, middleware components, or frontend components. The components of the system may be interconnected by any form or medium of digital data communication (e.g., a communications network). Examples of communication networks include: local area networks (LANs), wide area networks (WANs), and the Internet.

A computer system may include a client and a server. The client and server may be generally remote from each other and usually interact through a communication network. The client-server relationship may be generated by computer programs running on corresponding computers and having a client-server relationship with each other. The server may be a cloud server, also known as a cloud computing server or a cloud host, which is a host product in the cloud computing service system to solve the defects of difficult management and weak business scalability in traditional physical hosts and VPS (Virtual Private Server) services. The server may also be a server of a distributed system, or a server combined with blockchain.

It should be understood that the various forms of processes shown above can be used to reorder, add, or delete steps. For example, the steps described in this disclosure may be executed in parallel, sequentially, or in different orders, as long as the desired results of the technical solutions disclosed in this disclosure can be achieved, and this document does not limit them here.

In addition, the terms “first” and “second” are used for descriptive purposes only, and cannot be understood as indicating or implying relative importance or implicitly indicating the number of technical features indicated. Thus, the features associated with “first” and “second” may explicitly or implicitly include at least one of the features. In the description of this disclosure, the meaning of “multiple” is two or more, unless otherwise clearly and specifically defined.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. An image processing method comprising:
obtaining an image;
processing the image based on an image engine to determine feature information included in the image;
obtaining input content;
determining a target feature from the feature information included in the image based on the input content; and
generating a target image based at least on the target feature and the input content, the target image including a first object corresponding to the target feature and a second object corresponding to a content description of the target image generated based on the input content.

2. The method according to claim 1, wherein determining the target feature includes:
determining a matching feature from a first feature set and a second feature set as the target feature, the first feature set and the second feature set having a same type, the first feature set corresponding to the first image, and the second feature set corresponding to the input content.

3. The method according to claim 2, wherein:
the image is a first image; and
generating the target image includes:
determining the first object;
generating a second image based at least on a non-matching feature in the second feature set; and
obtaining the target image by fusing based on the first object and the second image.

4. The method according to claim 2, wherein:
the image is a first image; and
generating the target image includes:
determining the first object;
determining a second image by screening based at least on a non-matching feature in the second feature set and feature information of each picture in a picture set; and
obtaining the target image by fusing based on the first object and the second image.

5. The method according to claim 2, wherein:
the image is a first image; and
generating the target image includes:
determining the first object;
determining a first feature and a second feature based at least on a non-matching feature of the second feature set, the first feature indicating a target object;
determining the target object by screening based on the first feature and feature information of each picture in a picture set;
generating a second image based on the second feature; and
obtaining the target image by fusing based on the first object, the second object, and the second image.

6. The method according to claim 2, wherein:
obtaining the image includes obtaining the image through an image acquisition apparatus, the image including a geographical location at which the image is obtained; and
determining the matching feature includes determining a feature in the first feature set corresponding to the geographical location as the matching feature.

7. The method according to claim 1, wherein generating the target image includes:
generating a candidate image based on the target feature and the input content;
processing the candidate image based on an image-to-text model to generate text information of the candidate image;
determining a similarity between the text information of the candidate image and text information of the input content based on a semantic model; and
determining, in response to the similarity meeting a target threshold, the candidate image as the target image.

8. An electronic device comprising:
an image acquisition apparatus configured to obtain an image; and
a processor configured to:
process the image based on an image engine to determine feature information included in the image;
obtain input content;
determine a target feature from the feature information included in the image based on the input content; and
generate a target image based at least on the target feature and the input content, the target image including a first object corresponding to the target feature and a second object corresponding to a content description of the target image generated based on the input content.

9. The electronic device according to claim 8, wherein the processor is further configured to, when determining the target feature:
determine a matching feature from a first feature set and a second feature set as the target feature, the first feature set and the second feature set having a same type, the first feature set corresponding to the first image, and the second feature set corresponding to the input content.

10. The electronic device according to claim 9, wherein:
the image is a first image; and
the processor is further configured to, when generating the target image:
determine the first object;
generate a second image based at least on a non-matching feature in the second feature set; and
obtain the target image by fusing based on the first object and the second image.

11. The electronic device according to claim 9, wherein:
the image is a first image; and
the processor is further configured to, when generating the target image:
determine the first object;
determine a second image by screening based at least on a non-matching feature in the second feature set and feature information of each picture in a picture set; and
obtain the target image by fusing based on the first object and the second image.

12. The electronic device according to claim 9, wherein:
the image is a first image; and
the processor is further configured to, when generating the target image:
determine the first object;
determine a first feature and a second feature based at least on a non-matching feature of the second feature set, the first feature indicating a target object;
determine the target object by screening based on the first feature and feature information of each picture in a picture set;
generate a second image based on the second feature; and
obtain the target image by fusing based on the first object, the second object, and the second image.

13. The electronic device according to claim 9, wherein:
the image includes a geographical location at which the image is obtained; and
the processor is further configured to, when determining the matching feature, determine a feature in the first feature set corresponding to the geographical location as the matching feature.

14. The electronic device according to claim 8, wherein the processor is further configured to, when generating the target image:
generate a candidate image based on the target feature and the input content;
process the candidate image based on an image-to-text model to generate text information of the candidate image;
determine a similarity between the text information of the candidate image and text information of the input content based on a semantic model; and
determine, in response to the similarity meeting a target threshold, the candidate image as the target image.

15. An image processing method comprising:
inputting a candidate image into an image-to-text model to generate text information;
determining, based on a semantic model, a similarity between the text information of the candidate image and text information of an input content; and
in response to the similarity meeting a target threshold, outputting the candidate image as a target image.

16. The image processing method of claim 15, further comprising:
processing an input image based on an image engine to determine feature information included in the input image;
determining, based on the input content, a target feature from the feature information included in the input image; and
generating the candidate image based on the target feature and the input content.
